(19) United States
(12) Patent Application Publication
(10) Pub. No.: US 2025/0038287 A1
(43) Pub. Date: Jan. 30, 2025

(54) METHOD FOR REMOVING IMPURITY AND RECOVERING HIGH-CONCENTRATION LITHIUM AQUEOUS SOLUTION FROM WASTE BATTERY MATERIAL AND WASTE CATHODE ACTIVE MATERIALS

(71) Applicant: ECOPRO MATERIALS CO., LTD., Pohang (KR)

(72) Inventors: Dong Hee KIM, Pohang-si (KR); Dong Min SHIN, Pohang-si (KR); Gyeongeun BAEK, Pohang-si (KR); Min Ho SON, Pohang-si (KR)

(73) Assignee: ECOPRO MATERIALS CO., LTD., Pohang (KR)

(21) Appl. No.: 18/508,600

(22) Filed: Nov. 14, 2023

(30) Foreign Application Priority Data
Jul. 25, 2023 (KR) 10-2023-0096815

(51) Int. Cl. H01M 10/54; C22B 1/02; C22B 3/00; C22B 26/12; C22B 47/00

(52) U.S. Cl. CPC H01M 10/54; C22B 1/02; C22B 23/0415; C22B 26/12; C22B 47/0063

(57) ABSTRACT

A present disclosure provides a method for removing impurities and recovering a high-concentration lithium aqueous solution from a waste battery material and a waste cathode active materials which can separate valuable metals including nickel and cobalt in a solid state separately and manufacture them into the high-concentration lithium aqueous solution in the process of recovering lithium contained in the waste battery material and the waste cathode active materials

### CROSS-REFERENCE TO RELATED APPLICATIONS

A claim for priority under 35 U.S.C. § 119 is made to Korean Patent Application No. 10-2023-0096815 filed on Jul. 25, 2023 in the Korean Intellectual Property Office, the entire contents of which are hereby incorporated by reference.

### BACKGROUND

Recent developments in information and communication industry enable compact, lightweight, thin, and portable electronic devices, and thus high energy densification of batteries used as power supplies of such electronic devices are increasingly demanded. A lithium secondary battery may be a most suitable one to satisfy such demands, and thus studies on the lithium secondary battery are being actively carried out. The lithium secondary battery includes a cathode, an anode, electrolyte, and a separator that provides a moving path of lithium ions between the cathode and the anode, and generates electrical energy by the oxidation-reduction reaction of lithium ions in the cathode and the anode.

With the increasing demand of the lithium secondary battery, the amount of waste lithium ion batteries that have reached the end of their lifespan (hereinafter referred to as “waste batteries”) are also increasing. However, since useful materials such as valuable metals are included in the waste battery, the technical development of recovering the valuable metals from the waste battery has been demanded. Here, the valuable metals may include nickel, cobalt, and lithium.

To recover the valuable metals from the waste battery, the waste battery may be discharged, crushed, grinded, and sorted, and may be manufactured into a waste battery material in a powder form in which a cathode active materials (e.g., LiCoO₂, LiMnO₂, Li(NiₓCo_{y}Al_{z})O₂, etc.) and an anode material (e.g., graphite) are mixed.

Meanwhile, a waste cathode active materials may be produced in the manufacture process of the lithium ion secondary battery. The waste cathode active materials does not include grinded materials of an anode material, a cathode current collector, and an anode current collector, but includes lithium (Li) of about 6 to 7%.

Generally, hydrometallurgy is one of methods for recovering valuable metals from a raw material including a waste battery material and a waste cathode active materials. According to the hydrometallurgy, the valuable metals are recovered from the lithium ion secondary battery by dissolving the waste battery material and a waste cathode active materials, removing impurities, extracting solvent, and concentration/crystallization.

However, in the case of recovering valuable metals with the hydrometallurgy, there are problems that the recovery rate of lithium is not good, and the environmental problems occur such as ecotoxicity due to discharge of wastewater.

### PRIOR ART LITERATURE

(Patent Document 1) Republic of Korea Patent Registration No. 10-1682217 (published on Nov. 28, 2016)

### SUMMARY

To solve the technical problem, the present disclosure provides a method for removing impurities and recovering a high-concentration lithium aqueous solution from a waste battery material and a waste cathode active materials which can separate valuable metals including nickel and cobalt in a solid state separately and manufacture them into the high-concentration lithium aqueous solution in the process of recovering lithium contained in the waste battery material and the waste cathode active materials.

Furthermore, the present disclosure provides a method for removing impurities and recovering a high-concentration lithium aqueous solution from a waste battery material and a waste cathode active materials which can reduce the generation of Na salt and Ca salt, and separate impurities and valuable metals including nickel and cobalt contained in a first aqueous lithium solution recovered by subdividing a precipitation process, thereby obtaining the high-concentration lithium aqueous solution by replacing the first aqueous lithium solution including an alkaline substance produced in the process of recovering a valuable metal from a waste battery material and a waste cathode active materials by a pH adjuster.

Technical problems of the inventive concept are not limited to the technical problems mentioned above, and other technical problems not mentioned will be clearly understood by those skilled in the art from the following description.

According to an embodiment, a method for removing impurities and recovering a high-concentration lithium aqueous solution from a waste battery material and a waste cathode active materials may include a reduction and heat treatment step comprising adding a reducing agent to a raw material including the waste battery material and the waste cathode active materials and heat-treating the raw material to obtain a lithium compound; a water washing step comprising adding water to the heat-treated raw material to obtain a first aqueous lithium solution in which the lithium compound is dissolved and a water washing residue not dissolved in the water; an acid washing step comprising performing a solid-liquid separation with the first aqueous lithium solution and the water washing residue, and adding an acidic solubilizer to the water washing residue to obtain an acid solution in which the valuable metals including lithium, nickel, cobalt, and manganese and the impurities including aluminum, iron, and chrome are dissolved and an acid washing residue not dissolved in the acidic solubilizer; and an impurity precipitation step comprising performing a solid-liquid separation with the acid solution and the acid washing residue, and adding the first aqueous lithium solution to increase pH to the acid solution as a pH adjuster to obtain an impurity residue in which the impurities included in the acid solution is precipitated; and a valuable metal precipitation step comprising adding the pH adjuster to obtain a precipitation residue in which nickel, cobalt, and manganese are precipitated and a second aqueous lithium solution in which lithium remains, wherein the first aqueous lithium solution recovered in the water washing step is used for the pH adjuster.

Furthermore, the pH adjuster may be added until pH of the acid solution is adjusted in a range of 3 to 5.5 in the impurity precipitation step.

Furthermore, the method may further include an additional washing step of washing at least one of the impurity residue or the precipitation residue to obtain wash liquid in which an alkaline substance and the lithium compound are dissolved, and based the reduction and heat treatment step to the additional washing step being repeated, the water washing step comprising adding the wash liquid by replacing the water to recover the high-concentration lithium aqueous solution.

Furthermore, the reducing agent added in the reduction and heat treatment step may include sodium, a sodium compound may be further obtained after the heat treatment in the reduction and heat treatment step, and the sodium compound may be further dissolved in the first aqueous lithium solution.

Furthermore, the water may be added to the heat-treated raw material with a solid-liquid ratio of 1:1 to 1:30 in the water washing step.

Furthermore, the water washing step may be performed for 30 to 240 minutes in a temperature range of 5 to 90° C.

Furthermore, the acidic solubilizer may include at least one of an inorganic acid or an organic acid.

Furthermore, the inorganic acid may include at least one of sulfuric acid, hydrochloric acid, or nitric acid, and the organic acid may include at least one of oxalic acid, citric acid, or malic acid.

Furthermore, the acid washing step may be performed for 30 to 240 minutes in a temperature range of 5 to 90° C.

Furthermore, the acidic solubilizer may be added to the water washing residue with a ratio of 1:1 to 1:10 in the acid washing step.

Furthermore, the pH adjuster may be added until pH of the acid solution is adjusted in a range of 8 to 11 in the valuable metal precipitation step.

Furthermore, the valuable metal precipitation step may be performed for 30 to 600 minutes in a temperature range of 5 to 90° C.

Other detailed matters according to an embodiment of the inventive concept are included in the detailed description and drawings.

### BRIEF DESCRIPTION OF THE FIGURES

FIG. 1 is a flowchart illustrating a method for removing impurities and recovering a high-concentration lithium aqueous solution from a waste battery material and a waste cathode active materials according to an embodiment of the present disclosure.

FIG. 2 is a graph illustrating a concentration change of the second aqueous lithium solution according to a process circulation.

FIG. 3 is a graph illustrating the behavior of the valuable metal of the waste battery material according to a pH level in the impurity precipitation step.

FIG. 4 is a graph illustrating the XRD diffraction analysis of the valuable metal of the waste battery material according to the precipitation residue recovered in the valuable metal precipitation step and the impurity residue recovered in the impurity precipitation step.

### DETAILED DESCRIPTION

Advantages and features of the inventive concept and methods for achieving them will be apparent with reference to embodiments described below in detail in conjunction with the accompanying drawings. However, the inventive concept is not limited to the embodiments disclosed below, but can be implemented in various forms, and these embodiments are to make the disclosure of the inventive concept complete, and are provided so that this disclosure will be thorough and complete and will fully convey the scope of the invention to those of ordinary skill in the art, which is to be defined only by the scope of the claims.

The terminology used herein is for the purpose of describing particular embodiments only and is not intended to be limiting of the inventive concept. The singular expressions include plural expressions unless the context clearly dictates otherwise. In this specification, the terms “comprises” and/or “comprising” are intended to specify the presence of stated elements, but do not preclude the presence or addition of elements. Like reference numerals refer to like elements throughout the specification, and “and/or” includes each and all combinations of one or more of the mentioned elements. Although “first”, “second”, and the like are used to describe various components, these components are of course not limited by these terms. These terms are only used to distinguish one component from another. Thus, a first element discussed below could be termed a second element without departing from the teachings of the inventive concept.

Unless otherwise defined, all terms (including technical and scientific terms) used herein have the same meaning as commonly understood by one of ordinary skill in the art to which this invention belongs. It will be further understood that terms such as those defined in commonly used dictionaries, will not be interpreted in an idealized or overly formal sense unless expressly so defined herein.

Hereinafter, embodiments of the present disclosure will be described with reference to the accompanying drawings.

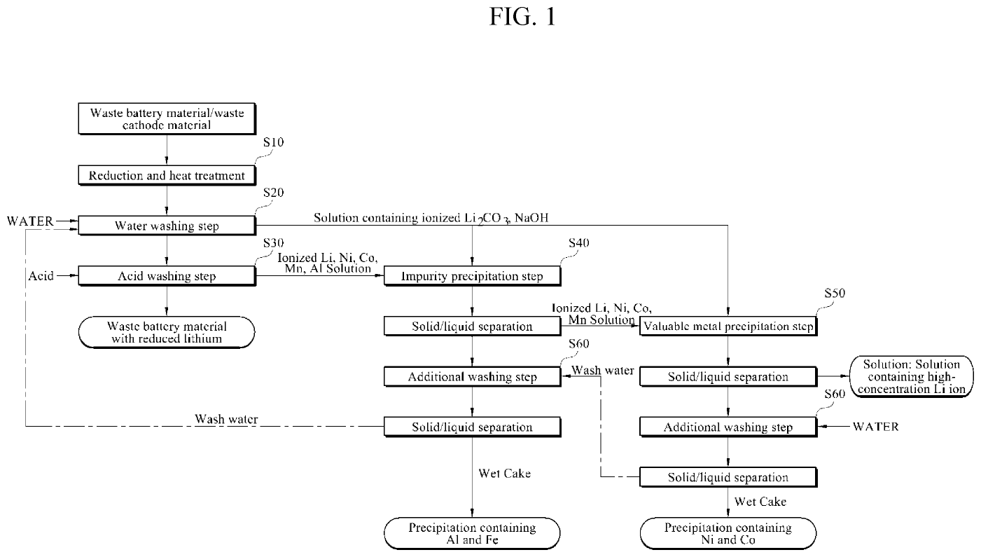

FIG. 1 is a flowchart illustrating a method for removing impurities and recovering a high-concentration lithium aqueous solution from a waste battery material and a waste cathode active materials according to an embodiment of the present disclosure.

As shown in FIG. 1, the method for recovering a valuable metal from a waste battery material and a waste cathode active materials according to an embodiment of the present disclosure may include a reduction and heat treatment step (S10), a water washing step (S20), an acid washing step (S30), an impurity precipitation step (S40), and a valuable metal precipitation step (S50).

In the reduction and heat treatment step (S10), a reducing agent may be added to a raw material including the waste battery material and the waste cathode active materials, and the raw material may be heat-treated to obtain a lithium compound. For example, the lithium compound may include Li₂CO₃ and 2Li₂O.

In one example, the waste battery material used in the reduction and heat treatment step (S10) may be a waste battery which is discharged, crushed, grinded, and sorted, and manufactured into the waste battery material in a powder form. The waste battery material may include lithium of 3% to 4%, a binder, and electrolyte. Depending on a type of the waste battery, the binder and the electrolyte may not be included.

In one example, the waste cathode active materials used in the reduction and heat treatment step (S10) may be generated due to a poor manufacturing process of the cathode active materials. The waste cathode active materials may not include grinded materials of an anode material, a cathode current collector, and an anode current collector, but may include lithium (Li) of about 6% to 7%, aluminum, and a binder. Aluminum and the binder may not be included depending on a type of the waste cathode active materials. Furthermore, the raw material including the waste battery material and the waste cathode active materials may include lithium, nickel, cobalt, and manganese in the form of cathode oxide form. For example, the cathode oxide may include at least one of lithium cobalt oxide (LiCoO₂), lithium nickel cobalt manganese oxide (LiNiCoMnO₂), or lithium manganese oxide (LiMnO₂).

In one example, in the reduction and heat treatment step (S10), carbon dioxide may be generated by the reaction between the binder, the anode material, and the organic material contained in the raw material and oxygen or the combustion of oxygen, and the reduction reaction occurs between the carbon dioxide and the cathode oxide contained in the raw material, and thus, the lithium compound may be obtained. In this case, the reduction reaction occurs between the carbon dioxide and the cathode oxide contained in the raw material may be defined by Reaction formula 1.

4 LiMeO₂+C→2Li₂O+CO2+4MeO

Li₂O+CO₂→Li₂CO₃ [Reaction formula 1]

Herein, Me may be any one of Ni, Co, and Mn.

In one example, the reducing agent added in the reduction and heat treatment step (S10) may contain sodium. In this case, a sodium compound may be further obtained after the heat treatment of the raw material in the reduction and heat treatment step (S10). For example, the sodium compound may include Na₂O, NaO₂, and Na₂O. The sodium compound may be dissolved in the water added in the heat-treated raw material in the water washing step (S20) that will be described below.

In the water washing step (S20), water is added to the heat-treated raw material to obtain a first aqueous lithium solution in which the lithium compound is dissolved and a water washing residue not dissolved in the water. In this case, the dissolution rate of the lithium compound with respect to the water may be proportional to the amount of the lithium compound obtained in the reduction and heat treatment step (S10). However, as the amount of Li₂CO₃ hardly dissolved in the water in the lithium compound obtained in the reduction and heat treatment step (S10) increases, the dissolution rate of the lithium compound with respect to the water may be strongly influenced by the water which is added. Later, the first aqueous lithium solution recovered by the solid-liquid separation in the acid washing step (S30) to be described below may be replaced and used by a pH adjuster in the valuable metal precipitation step (S40) to be described below as an alkaline substance like Li₂CO₃ is contained in the first aqueous lithium solution.

In one example, the reducing agent added in the reduction and heat treatment step (S10) may contain sodium, and the sodium compound may be formed in the heat treatment process of the reducing agent containing sodium and the raw material. For example, the sodium compound may include Na₂O, NaO₂, and Na₂O. Thereafter, the sodium compound may be further dissolved in the first aqueous lithium solution in the water washing step (S20), in the sodium compound, Na₂O may be dissolved in the water, and NaOH may be generated. In this case, the dissolution reaction of Na₂O and the water may be defined by Reaction formula 2.

Na₂O+H₂O→2NaOH [Reaction formula 2]

Thereafter, the lithium compound and the sodium compound may be dissolved in the first aqueous lithium solution recovered by the solid-liquid separation in the acid washing step (S30) to be described below. As the alkaline substance such as Li₂CO₃ and NaOH is contained in the first aqueous lithium solution, the first aqueous lithium solution may be replaced and used by the pH adjuster in the valuable metal precipitation step (S50) to be described below, and the pH adjustment efficiency may be improved.

In one example, in the water washing step (S20), the water may be added to the heat-treated raw material with a solid-liquid ratio of 1:1 to 1:30. In this case, considering that the dissolution rate of the lithium compound with respect to the water increases as the proportion of the water increases but the concentration of NaOH generated by the dissolution reaction of Na₂O and the water decreases, and the movement and the filtration of the water washing residue becomes difficult as the proportion of the water decreases, it may be preferable that the water may be added to the heat-treated raw material with a solid-liquid ratio of 1:2 to 1:5 in the water washing step (S20).

In one example, the water washing step (S20) may be performed for 30 to 240 minutes in a temperature range of 5 to 90° C. More preferably, the water washing step (S20) may be performed for 60 to 120 minutes in a temperature range of 5 to 90° C. The applicant drives the numerical values for temperature and time of the water washing step (S20) throughout various experiences and experiments as described above, but the present disclosure is not limited thereto.

The acid washing step (S30) may include performing a solid-liquid separation with the first aqueous lithium solution and the water washing residue, and then, adding an acidic solubilizer to the water washing residue to obtain an acid solution in which the valuable metals including lithium, nickel, cobalt, and manganese are dissolved and an acid washing residue not dissolved in the acidic solubilizer. In the acid washing step (S30), the first aqueous lithium solution may be recovered by the solid-liquid separation between the first aqueous lithium solution and the water washing residue.

In one example, the acidic solubilizer may include at least one of an inorganic acid or an organic acid. That is, either one of the inorganic acid or the organic acid may be solely used, or a mixture of the inorganic acid and the organic acid may be used for the acidic solubilizer. Here, the inorganic acid may include at least one of sulfuric acid, hydrochloric acid, or nitric acid, and the organic acid may include at least one of oxalic acid, citric acid, or malic acid. In addition, the inorganic acid may be added with 1 wt % to 50 wt %, and the organic acid may be added with 1 wt % to 80 wt %. More preferably, the inorganic acid may be added with 5 wt % to 20 wt %, and the organic acid may be added with 10 wt % to 40 wt %.

In one example, in the acid washing step (S30), the acidic solubilizer may be added to the water washing residue with a ratio of 1:1 to 1:10. In this case, the dissolution rate of lithium with respect to the acidic solubilizer may be in proportion to an amount of input of the acidic solubilizer, but the valuable metals such as nickel or cobalt may be dissolved together in the acidic solubilizer. However, as the amount of the dissolved nickel and cobalt increases in addition to lithium in the acidic solubilizer, an input amount of the pH adjuster for pH adjustment and precipitation in the valuable metal precipitation step (S50) to be described below may increase, and accordingly, the generation of sodium sulfate, which is waste material, may also increase. Therefore, in the acid washing step (S30), it is preferable that the acidic solubilizer is added to the water washing residue with the solid-liquid ratio described above.

In one example, the acid washing step (S30) may be performed for 30 to 240 minutes in a temperature range of 5 to 90° C. More preferably, the acid washing step (S30) may be performed for 60 to 120 minutes in a temperature range of 5 to 90° C. The applicant drives the numerical values for temperature and time of the acid washing step (S30) throughout various experiences and experiments as described above, but the present disclosure is not limited thereto.

The impurity precipitation step (S40) may include performing a solid-liquid separation with the acid solution and the acid washing residue, and then, adding the first aqueous lithium solution to increase pH to the acid solution as a pH adjuster to obtain an impurity residue in which the impurities included in the acid solution is precipitated.

As the pH adjuster added in the impurity precipitation step (S40), the first aqueous lithium solution recovered in the water washing step (S20) is used. Accordingly, the first aqueous lithium solution in which the lithium compound, which is recovered in the water washing step (S20), is dissolved is replaced by the pH adjuster in the impurity precipitation step (S40), and an inflow of Na ions or Ca ions, which are generated by adding the pH adjuster used in the conventional process of precipitating valuable metals is prevented, thereby reducing waste water generation and the expense for processing waste water.

In one example, the pH adjuster may be added until pH of the acid solution is adjusted in a range of 3 to 5.5 in the impurity precipitation step (S40).

In one example, the impurity precipitation step (S40) may be performed for 30 to 600 minutes in a temperature range of 30 to 60° C. The applicant drives the numerical values for temperature and time of the impurity precipitation step (S40) throughout various experiences and experiments as described above, but the present disclosure is not limited thereto.

The valuable metal precipitation step (S50) may include adding the pH adjuster to increase pH to the acid solution recovered in the impurity precipitation step (S40) to obtain a precipitation residue in which nickel, cobalt, and manganese are precipitated and a second aqueous lithium solution in which lithium remains. Thereafter, as occasion demands, a solid-liquid separation is performed with the precipitation residue and the second aqueous lithium solution, and the precipitation residue and the second aqueous lithium solution may be separated and recovered.

The pH adjuster added in the valuable metal precipitation step (S50) may use the first aqueous lithium solution recovered in the water washing step (S20). Accordingly, the first aqueous lithium solution in which the lithium compound, which is recovered in the water washing step (S20), is dissolved is replaced by the pH adjuster in the valuable metal precipitation step (S50), and an inflow of Na ions or Ca ions, which are generated by adding the pH adjuster used in the conventional process of precipitating valuable metals is prevented, thereby reducing waste water generation and the expense for processing waste water.

In one example, a lithium compound Li₂CO₃ may be dissolved in the first aqueous lithium solution. In another example, in the case that the reducing agent containing sodium is added in the reduction and heat treatment step (S10), a lithium compound Li₂CO₃ and a sodium compound NaOH may be dissolved in the first aqueous lithium solution. The precipitation reaction of the first aqueous lithium solution, nickel, cobalt, and manganese may be defined by Reaction formula 3.

Li₂CO₃+MeSO₄→MeCO₃+Li₂SO₄

2NaOH+MeSO₄→Me(OH)₂+Na₂So₄ [Reaction formula 3]

Herein, Me may be either one of Ni, Co, and Mn.

In one example, in the valuable metal precipitation step (S50), the pH adjuster may be added until pH of the acid solution is adjusted in a range of 8 to 11. More preferably, in the valuable metal precipitation step (S50), the pH adjuster may be added until pH of the acid solution is adjusted in a range of 9 to 10.

In one example, the valuable metal precipitation step (S50) may be performed for 30 to 240 minutes in a temperature range of 5 to 90° C. The applicant drives the numerical values for temperature and time of the valuable metal precipitation step (S50) throughout various experiences and experiments as described above, but the present disclosure is not limited thereto.

In one example, as a solid-liquid separation device, a sedimentation type, a pressure filtration type, a decompression filtration type, a centrifugal dehydration type, and the like may be used, but the present disclosure is not limited thereto.

Meanwhile, the alkaline substance and the lithium compound may remain on surfaces of the impurity residue recovered in the impurity precipitation step (S40) and the precipitation residue recovered in the valuable metal precipitation step (S50), and the alkaline substance and the lithium compound may be recovered in an additional washing step (S60) to be described below.

In the additional washing step (S60), at least one of the impurity residue or the precipitation residue may be washed by wash water, and wash liquid in which the alkaline substance and the lithium compound are dissolved may be obtained. Here, the alkaline substance may be a compound of ionized lithium and sodium.

In one example, the reduction and heat treatment step (S10) to the additional washing step (S60) may be repeated to recover the high-concentration lithium aqueous solution. As such, in the case that the reduction and heat treatment step (S10) to the additional washing step (S60) are repeated, in the water washing step (S20), the wash liquid may be added by replacing water.

In one example, in the additional washing step (60), the water washing residue recovered in the water washing step (S20) may be also washed by the wash water, and the wash liquid may be obtained, in which the alkaline substance and the lithium compound are dissolved.

In one example, a separate additional wash water circulation line may be provided in the solid-liquid separation device, the wash water may be circulated with the acid washing residue which is solid-liquid separated in the acid washing step (S30).

In one example, in the additional washing step (60), a residue including at least one of the impurity residue recovered in the impurity precipitation step (S40) or the precipitation residue recovered in the valuable metal precipitation step (S50) and the wash water may be added in 1:1 to 1:10 of weight percent.

In one example, the wash liquid recovered in the additional washing step (60) may be circulated as described below. In the additional washing step (60), a second wash liquid recovered by washing of the wash water of the precipitation residue may be added in the impurity precipitation step (S40). In the additional washing step (60), a third wash liquid recovered by washing the wash water of the impurity residue may be added in the water washing step (S20).

Hereinafter, the step and the output of the step of the present disclosure will be described in detail through experimental examples and XRD analyses.

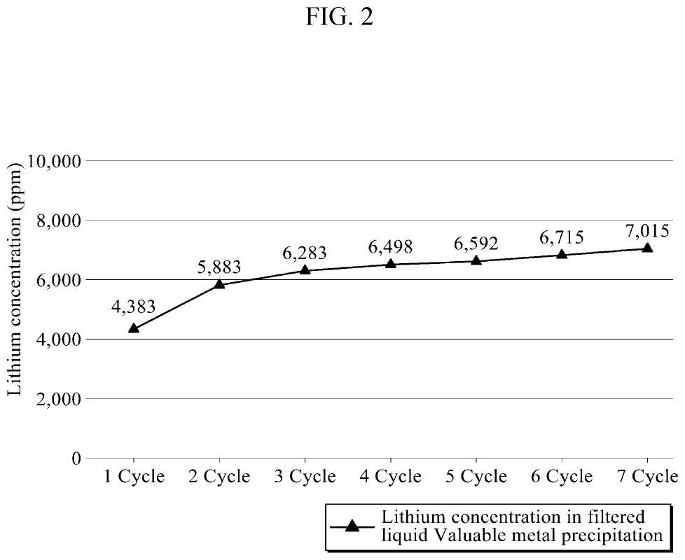

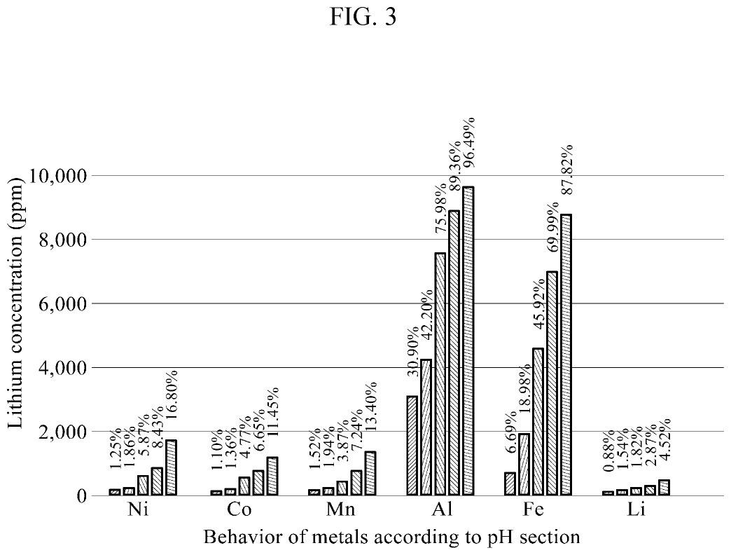

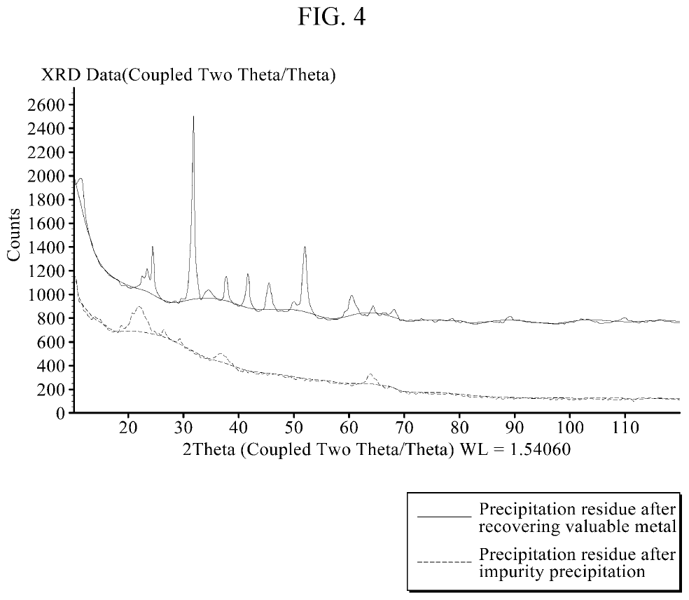

FIG. 2 is a graph illustrating a concentration change of the second aqueous lithium solution according to a process circulation, FIG. 3 is a graph illustrating the behavior of the valuable metal of the waste battery material according to a pH level in the impurity precipitation step, and FIG. 4 is a graph illustrating the XRD diffraction analysis of the valuable metal of the waste battery material according to the precipitation residue recovered in the valuable metal precipitation step and the impurity residue recovered in the impurity precipitation step. For reference, the filtered liquid after the valuable metal precipitation shown in FIG. 2 is the second aqueous lithium solution.

### Experimental Example

### 1. Reduction and Heat Treatment Step

In the waste battery material of 100 weight percent, Na₂CO₃, Graphite, and activated carbon, which are reducing agents, are added and heat-treated, and then, the waste battery material of 132 weight percent, which is reduced and heat-treated, is recovered. In this case, 10 to 40 weight percent of the reducing agents are added. Thereafter, to identify the composition of the reduced and heat-treated waste battery material, the result as represented in Table 1 is identified by using an ICP OES analysis equipment.

TABLE 1

| | Sample name | | | | | | | | | |
|---|---|---|---|---|---|---|---|---|---|---|
| | Ni | Co | Mn | CU | Fe | Zn | Al | Li | Na | S |
| | wt % | | | ppm | | | | | | |
| Waste battery | 18.66 | 6.18 | 5.65 | 5094 | 3068 | 13 | 32716 | 40893 | 4899 | 1045 |
| material | | | | | | | | | | |
| Waste battery | 13.86 | 4.50 | 4.15 | 3521 | 3127 | 21 | 25884 | 30120 | 79849 | 1598 |
| material after | | | | | | | | | | |
| Reduction and | | | | | | | | | | |
| heat treatment | | | | | | | | | | |

### 2. Water Washing Step

The reduced and heat-treated waste battery material of 132 weight percent and water 592 weight percent are added, and mixed and stirred for 1 hour in a room temperature condition, thereby the water washing step being performed. Thereafter, the slurry is separated with a liquid phase and a solid phase by using the solid-liquid separation device, and the first aqueous lithium solution of 487 weight percent and the water washing residue of 159 weight percent are recovered. Later, the analysis result is identified by using an ICP OES analysis equipment for each sample as represented in Table 2.

Referring to Table 2, it is identified that the lithium compound of the waste battery material which is reduced and heat-treated in the water washing step is dissolved in water. In addition, a large amount of Na ions dissolved in water is identified in the first aqueous lithium solution, and pH of the first aqueous lithium solution measured in the sample is 11.92, which identifies the alkaline substance.

TABLE 2

| | Sample name | | | | | | | | | |
|---|---|---|---|---|---|---|---|---|---|---|
| | Ni | Co | Mn | CU | Fe | Zn | Al | Li | Na | S |
| | wt % | | | ppm | | | | | | |
| First | 0 | 0 | 0 | 0 | 0 | 0 | 26 | 2143 | 17736 | 24 |
| aqueous | | | | | | | | | | |
| lithium | | | | | | | | | | |
| solution | | | | | | | | | | |
| after water | | | | | | | | | | |
| washing | | | | | | | | | | |
| Water | 16.14 | 5.25 | 4.84 | 4314 | 3411 | 24 | 29345 | 25740 | 14643 | 1342 |
| washing | | | | | | | | | | |
| residue after | | | | | | | | | | |
| water | | | | | | | | | | |
| washing | | | | | | | | | | |

### 3. Acid Washing Step

Sulfuric acid of 10 wt % is added to the water washing residue of 159 weight percent with a ratio of 1:2, and mixed and stirred for 1 hour in a room temperature condition, thereby the acid washing step (S30) being performed. Thereafter, the slurry is separated with a liquid phase and a solid phase into the acid solution and the acid washing residue by using the solid-liquid separation device, and the acid washing residue of 149 weight percent and the acid solution of 336 weight percent are recovered. In this case, to recover the acid and the valuable metal contained in a surface of the acid washing residue, the wash water is added to the acid washing residue, and the first wash liquid of 138 weight percent is recovered. Later, the analysis result is identified by using an ICP OES analysis equipment for each sample as represented in Table 3.

TABLE 3

| | Sample name | | | | | | | | | |
|---|---|---|---|---|---|---|---|---|---|---|
| | Ni | Co | Mn | CU | Fe | Zn | Al | Li | Na | S |
| | wt % | | | ppm | | | | | | |
| First wash | 0.56 | 0.41 | 1.41 | 0 | 511 | 0 | 2806 | 6490 | 3346 | 27042 |
| liquid after | | | | | | | | | | |
| acid washing | | | | | | | | | | |
| Acid | 0.15 | 0.08 | 0.40 | 0 | 54 | 0 | 142 | 1974 | 2197 | 9033 |
| washing | | | | | | | | | | |
| residue after | | | | | | | | | | |
| acid washing | | | | | | | | | | |
| First wash | 18.42 | 5.10 | 0.35 | 4382 | 2526 | 15 | 26324 | 5173 | 2117 | 9745 |
| liquid after | | | | | | | | | | |
| acid washing | | | | | | | | | | |

Referring to Table 3, it is identified the result that the lithium contained in the water washing residue after the water washing is additionally recovered through the acid washing step. Meanwhile, after the acid washing step, as a method for recovering the valuable metal such as nickel, cobalt, and the like from the acid solution, the precipitation reaction through the pH adjustment in the solution may be used. By adding the pH adjuster and the precipitation agent, pH of the solution may be adjusted in a range of about 3.5 to 4.5.

### 4-1. Impurity Precipitation Step (pH 3.8)

In this embodiment, the impurity precipitation step is progressed in pH 3.8 for the acid solution of 336 weight percent after the acid washing. In this case, the first aqueous lithium solution recovered by the solid-liquid separation in the acid washing step is used by replacing the existing NaOH and Na₂CO₃, as the added pH adjuster and the precipitation agent, and the impurity precipitation step is progressed for about 1 hours in a temperature range of 50 to 60° C.

As a result, the slurry is separated with a liquid phase and a solid phase by using the solid-liquid separation device in the reaction condition of pH 3.8, and after the impurity precipitation, the acid solution of 342 weight percent and the impurity residue of 11 weight percent are recovered. Here, since the alkaline substance and remaining lithium are existed on a surface of the impurity residue, the wash water is added to the impurity residue to recover the alkaline substance and remaining lithium, and in this process, the second wash liquid of 108 weight percent is recovered after the impurity precipitation. Later, the second wash liquid is completely dried after the impurity precipitation, and the completely dried impurity residue of 4 weight percent is identified. The analysis result is identified by using an ICP OES analysis equipment for each sample as represented in Table 4, FIG. 3, and FIG. 4.

TABLE 4

| | Sample name | | | | | | | | | |
|---|---|---|---|---|---|---|---|---|---|---|
| | Ni | Co | Mn | CU | Fe | Zn | Al | Li | Na | S |
| | wt % | | | ppm | | | | | | |
| Acid solution | 0.52 | 0.38 | 1.33 | 0 | 482 | 0 | 1555 | 6390 | 4346 | 27342 |
| after impurity | | | | | | | | | | |
| precipitation | | | | | | | | | | |
| (pH 3.8) | | | | | | | | | | |
| Second wash | 0.06 | 0.05 | 0.08 | 0 | 8 | 0 | 47 | 274 | 318 | 749 |
| liquid after | | | | | | | | | | |
| impurity | | | | | | | | | | |
| precipitation | | | | | | | | | | |
| (pH 3.8) | | | | | | | | | | |
| Impurity | 0.78 | 0.42 | 2.09 | 0 | 8789 | 9 | 87519 | 7840 | 29441 | 97412 |
| residue after | | | | | | | | | | |
| complete dry | | | | | | | | | | |
| (pH 3.8) | | | | | | | | | | |

Referring to Table 4, it is identified the result that aluminum is precipitated in some of the impurity residue obtained after the impurity precipitation of pH 3.8 condition for the acid solution after the acid washing.

### 4-2. Impurity Precipitation Step (pH 4.2)

The impurity precipitation step is progressed in pH 4.2 for the acid solution of 342 weight percent after the impurity precipitation of pH 3.8 condition by adding the pH adjuster. In this case, as described above, the first aqueous lithium solution recovered by the solid-liquid separation in the acid washing step is used by replacing the existing NaOH and Na₂CO₃, as the added pH adjuster and the precipitation agent, and the impurity precipitation step is progressed for about 1 hours in a temperature range of 50 to 60° C.

Thereafter, the slurry is separated with a liquid phase and a solid phase by using the solid-liquid separation device in the reaction condition of pH 4.2, and after the impurity precipitation, the acid solution of 340 weight percent and the impurity residue of 16 weight percent are recovered. Here, since the alkaline substance and the remaining lithium are existed on a surface of the impurity residue, the wash water is added to the impurity residue to recover the alkaline substance and the remaining lithium, and in this process, the second wash liquid of 156 weight percent is recovered after the impurity precipitation. Later, the second wash liquid is completely dried after the impurity precipitation, and the completely dried impurity residue of 5 weight percent is identified. The analysis result is identified by using an ICP OES analysis equipment for each sample as represented in Table 4, FIG. 3, and FIG. 4.

TABLE 5

| | Sample name | | | | | | | | | |
|---|---|---|---|---|---|---|---|---|---|---|
| | Ni | Co | Mn | CU | Fe | Zn | Al | Li | Na | S |
| | wt % | | | ppm | | | | | | |
| Acid solution | 0.47 | 0.34 | 1.24 | 0 | 192 | 0 | 244 | 6342 | 4846 | 26314 |
| after impurity | | | | | | | | | | |
| precipitation | | | | | | | | | | |
| (pH 4.2) | | | | | | | | | | |
| Second wash | 0.04 | 0.05 | 0.11 | 10 | 16 | 0 | 17 | 325 | 316 | 845 |
| liquid after | | | | | | | | | | |
| impurity | | | | | | | | | | |
| precipitation | | | | | | | | | | |
| (pH 4.2) | | | | | | | | | | |
| Impurity | 2.07 | 1.16 | 4.53 | 0 | 20789 | 9 | 94718 | 8722 | 27234 | 89648 |
| residue after | | | | | | | | | | |
| complete dry | | | | | | | | | | |
| (pH 4.2) | | | | | | | | | | |

Referring to Table 4 and Table 5, it is identified the result that aluminum of about 87.3% is removed by the impurity residue obtained after the impurity precipitation through the pH adjustment of pH 3.8 to pH 4.2 for the acid solution after the acid washing.

### 5. Valuable Metal Precipitation Step

For the acid solution of 342 weight percent after the impurity precipitation, to recover the valuable metal such as nickel, cobalt, and the like in the solution, the first aqueous lithium solution is added and pH is adjusted up to 9.0. Thereafter, the slurry is separated with a liquid phase and a solid phase by using the solid-liquid separation device, and the second aqueous lithium solution of 524 weight percent after the precipitation reaction and the precipitation residue of 33 weight percent after the precipitation reaction are obtained. In this case, since the alkaline substance and the remaining lithium are existed on a surface of the precipitation residue, the wash water is added to the impurity residue, and in this process, the third wash liquid of 261 weight percent is recovered. Later, the precipitation residue is completely dried, and the precipitation residue of 12 weight percent is identified. The analysis result is identified by using an JCP QES analysis equipment for each sample as represented in Table 6.

TABLE 6

| | Sample name | | | | | | | | | |
|---|---|---|---|---|---|---|---|---|---|---|
| | Ni | Co | Mn | CU | Fe | Zn | Al | Li | Na | S |
| | wt % | | | ppm | | | | | | |
| Second | 0 | 0 | 0 | 0 | 0 | 0 | 0 | 4383 | 11159 | 15413 |
| aqueous | | | | | | | | | | |
| lithium | | | | | | | | | | |
| solution | | | | | | | | | | |
| after | | | | | | | | | | |
| precipitation | | | | | | | | | | |
| reaction | | | | | | | | | | |
| Third wash | 0.03 | 0.03 | 0.07 | 0 | 0 | 0 | 2 | 725 | 916 | 1117 |
| liquid after | | | | | | | | | | |
| precipitation | | | | | | | | | | |
| reaction | | | | | | | | | | |
| Precipitation | 12.34 | 8.73 | 32.92 | 10 | 1989 | 9 | 6942 | 6613 | 17234 | 19046 |
| residue after | | | | | | | | | | |
| precipitation | | | | | | | | | | |
| reaction | | | | | | | | | | |

Referring to Table 6, it is identified that all the valuable metal such as nickel, cobalt, and the like contained in the acid solution are recovered after the impurity precipitation after the valuable metal precipitation.

### 6. Concentration Change of the First Aqueous Lithium Solution and the Second Aqueous Lithium Solution According to the Process Circulation

Since the alkaline substance and the remaining lithium are existed on a surface of the residue which is separated from the slurry with a liquid phase and a solid phase after the precipitation in the impurity precipitation step and the valuable metal precipitation step, the residue is washed by wash water. In this case, lithium of about 1 g/L or smaller is existed in the wash liquid in which the alkaline substance and the remaining lithium are dissolved. However, too much energy is consumed to recover lithium by increasing the lithium concentration up to 18 g/L to 20 g/L using a general evaporation concentration method, and therefore, it is inefficient.

As an alternative method for this, by using the method of reusing and circulating the wash water used in the washing step, it is possible to increase the lithium concentration of the first aqueous lithium solution and the second aqueous lithium solution up to a target concentration. For this, for example, the wash water used in the washing step may be circulated in the following process.
1) After the valuable metal precipitation, the wash water recovered through the solid-liquid separation in the washing step is added to the valuable metal precipitation step.
2) After the impurity precipitation step, the wash water recovered through the solid-liquid separation in the washing step is added to the water washing step.
3) The wash water added in the water washing step is solid-liquid separated in the acid washing step, and added to the impurity precipitation step and the valuable metal precipitation step, thereby utilized as the pH adjuster.

The process is set as a single cycle and circulated by 7 times, and the result of the lithium concentration of the first aqueous lithium solution after the water washing and the lithium concentration of the second aqueous lithium solution after the valuable metal precipitation are identified as represented in Table 7 and FIG. 2.

TABLE 7

| | Sample name | | | | | | | | | |
|---|---|---|---|---|---|---|---|---|---|---|
| | Ni | Co | Mn | CU | Fe | Zn | Al | Li | Na | S |
| | wt % | | | ppm | | | | | | |
| 1^{st} cycle, first | 0 | 0 | 0 | 0 | 0 | 0 | 26 | 2143 | 17736 | 24 |
| aqueous lithium | | | | | | | | | | |
| solution after | | | | | | | | | | |
| water washing | | | | | | | | | | |
| 1^{st} cycle, | 0 | 0 | 0 | 0 | 0 | 0 | 0 | 4383 | 11159 | 15413 |
| second aqueous | | | | | | | | | | |
| lithium solution | | | | | | | | | | |
| after valuable | | | | | | | | | | |
| metal | | | | | | | | | | |
| precipitation | | | | | | | | | | |
| 2^{nd} cycle, first | 0.04 | 0.03 | 0.07 | 0 | 8 | 0 | 19 | 3944 | 28817 | 484 |
| aqueous lithium | | | | | | | | | | |
| solution after | | | | | | | | | | |
| water washing | | | | | | | | | | |
| 2^{nd} cycle, | 0 | 0 | 0 | 0 | 0 | 0 | 0 | 5883 | 16859 | \|17813 |
| second aqueous | | | | | | | | | | |
| lithium solution | | | | | | | | | | |
| after valuable | | | | | | | | | | |
| metal | | | | | | | | | | |
| precipitation | | | | | | | | | | |
| 3^{rd} cycle, first | 0.04 | 0.03 | 0.07 | 0 | 11 | 0 | 41 | 4672 | 29817 | 592 |
| aqueous lithium | | | | | | | | | | |
| solution after | | | | | | | | | | |
| water washing | | | | | | | | | | |
| 3^{rd} cycle, | 0 | 0 | 0 | 0 | 0 | 0 | 0 | 6283 | 17159 | 18213 |
| second aqueous | | | | | | | | | | |
| lithium solution | | | | | | | | | | |
| after valuable | | | | | | | | | | |
| metal | | | | | | | | | | |
| precipitation | | | | | | | | | | |
| 4^{th} cycle, first | 0.05 | 0.04 | 0.08 | 0 | 4 | 0 | 27 | 4842 | 31217 | 642 |
| aqueous lithium | | | | | | | | | | |
| solution after | | | | | | | | | | |
| water washing | | | | | | | | | | |
| 4^{th} cycle, | 0 | 0 | 0 | 0 | 0 | 0 | 0 | 6498 | 16959 | 17113 |
| second aqueous | | | | | | | | | | |
| lithium solution | | | | | | | | | | |
| after valuable | | | | | | | | | | |
| metal | | | | | | | | | | |
| precipitation | | | | | | | | | | |
| 5^{th} cycle, first | 0.05 | 0.04 | 0.09 | 0 | 14 | 0 | 38 | 4911 | 31817 | 714 |
| aqueous lithium | | | | | | | | | | |
| solution after | | | | | | | | | | |
| water washing | | | | | | | | | | |
| 5^{th} cycle, | 0 | 0 | 0 | 0 | 0 | 0 | 0 | 6592 | 17359 | 18112 |
| second aqueous | | | | | | | | | | |
| lithium solution | | | | | | | | | | |
| after valuable | | | | | | | | | | |
| metal | | | | | | | | | | |
| precipitation | | | | | | | | | | |
| 6^{th} cycle, first | 0.05 | 0.04 | 0.09 | 0 | 17 | 0 | 47 | 5011 | 30244 | 681 |
| aqueous lithium | | | | | | | | | | |
| solution after | | | | | | | | | | |
| water washing | | | | | | | | | | |
| 6^{th} cycle, | 0 | 0 | 0 | 0 | 0 | 0 | 0 | 6715 | 16897 | 17148 |
| second aqueous | | | | | | | | | | |
| lithium solution | | | | | | | | | | |
| after valuable | | | | | | | | | | |
| metal | | | | | | | | | | |
| precipitation | | | | | | | | | | |
| 7^{th} cycle, first | 0.06 | 0.05 | 0.10 | 0 | 16 | 0 | 44 | 5141 | 32244 | 781 |
| aqueous lithium | | | | | | | | | | |
| solution after | | | | | | | | | | |
| water washing | | | | | | | | | | |
| 7^{th} cycle, | 0 | 10 | 10 | 0 | 10 | 0 | 0 | 7015 | 18897 | 19148 |
| second aqueous | | | | | | | | | | |
| lithium solution | | | | | | | | | | |
| after valuable | | | | | | | | | | |
| metal | | | | | | | | | | |
| precipitation | | | | | | | | | | |

Referring to FIG. 7, it is identified that the lithium concentration of the first aqueous lithium solution after the water washing and the lithium concentration of the second aqueous lithium solution after the valuable metal precipitation increase as the cycle number increases. According to the method for removing impurities and recovering a high-concentration lithium aqueous solution from a waste battery material and a waste cathode active materials of the present disclosure, the impurities contained in the waste battery material and the waste cathode active materials are removed, and lithium is recovered, and there is an effect that valuable metals including nickel and cobalt may be separated in a solid state separately and manufactured into the high-concentration lithium aqueous solution in the process of recovering lithium.

Furthermore, according to the method for removing impurities and recovering a high-concentration lithium aqueous solution from a waste battery material and a waste cathode active materials of the present disclosure, the first aqueous lithium solution containing an alkaline substance produced in the process of recovering a valuable metal from a waste battery material and a waste cathode active materials is replaced and used by a pH adjuster, and accordingly, the generation of Na salt and Ca salt may be reduced. In addition, a precipitation process is subdivided, and the impurities and valuable metals including nickel and cobalt contained in the recovered aqueous lithium solution are separated separately, and there is an effect of obtaining the high-concentration lithium aqueous solution.

Effects of the inventive concept are not limited to the effects mentioned above, and other effects not mentioned will be clearly understood by those skilled in the art from the following description.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for removing impurities and recovering a high-concentration lithium aqueous solution from a waste battery material and a waste cathode active materials, the method comprising:
a reduction and heat treatment step comprising adding a reducing agent to a raw material including the waste battery material and the waste cathode active materials and heat-treating the raw material to obtain a lithium compound;
a water washing step comprising adding water to the heat-treated raw material to obtain a first aqueous lithium solution in which the lithium compound is dissolved and a water washing residue not dissolved in the water;
an acid washing step comprising performing a solid-liquid separation with the first aqueous lithium solution and the water washing residue, and adding an acidic solubilizer to the water washing residue to obtain an acid solution in which the valuable metals including lithium, nickel, cobalt, and manganese and the impurities including aluminum, iron, and chrome are dissolved and an acid washing residue not dissolved in the acidic solubilizer; and
an impurity precipitation step comprising performing a solid-liquid separation with the acid solution and the acid washing residue, and adding the first aqueous lithium solution to increase pH to the acid solution as a pH adjuster to obtain an impurity residue in which the impurities included in the acid solution is precipitated; and
a valuable metal precipitation step comprising adding the pH adjuster to obtain a precipitation residue in which nickel, cobalt, and manganese are precipitated and a second aqueous lithium solution in which lithium remains,
wherein the first aqueous lithium solution recovered in the water washing step is used for the pH adjuster.

2. The method of claim 1, wherein the pH adjuster is added until pH of the acid solution is adjusted in a range of 3 to 5.5 in the impurity precipitation step.

3. The method of claim 1, further comprising an additional washing step of washing at least one of the impurity residue or the precipitation residue with wash water to obtain wash liquid in which an alkaline substance and the lithium compound are dissolved,
wherein, based the reduction and heat treatment step to the additional washing step being repeated, the water washing step comprising adding the wash liquid by replacing the water to recover the high-concentration lithium aqueous solution.

4. The method of claim 1, wherein the reducing agent added in the reduction and heat treatment step includes sodium, wherein, a sodium compound is further obtained after the heat treatment in the reduction and heat treatment step, and wherein the sodium compound is further dissolved in the first aqueous lithium solution.

5. The method of claim 1, wherein the water is added to the heat-treated raw material with a solid-liquid ratio of 1:1 to 1:30 in the water washing step.

6. The method of claim 1, wherein the water washing step is performed for 30 to 240 minutes in a temperature range of 5 to 90° C.

7. The method of claim 1, wherein the acidic solubilizer includes at least one of an inorganic acid or an organic acid.

8. The method of claim 7, wherein the inorganic acid includes at least one of sulfuric acid, hydrochloric acid, or nitric acid, and
wherein the organic acid includes at least one of oxalic acid, citric acid, or malic acid.

9. The method of claim 1, wherein the acid washing step is performed for 30 to 240 minutes in a temperature range of 5 to 90° C.

10. The method of claim 1, wherein the acidic solubilizer is added to the water washing residue with a ratio of 1:1 to 1:10 in the acid washing step.

11. The method of claim 1, wherein the pH adjuster is added until pH of the acid solution is adjusted in a range of 8 to 11 in the valuable metal precipitation step.

12. The method of claim 1, wherein the valuable metal precipitation step is performed for 30 to 600 minutes in a temperature range of 5 to 90° C.
